(19) United States
(12) Patent Application Publication
(10) Pub. No.: US 2006/0260533 A1
(43) Pub. Date: Nov. 23, 2006

(54) EXPIRATION WARNING PATCH FOR GAS EXPIRATION DATE MANAGEMENT

(76) Inventor: Thomas Parias, Croisy-sur-Seine (FR)

Correspondence Address: Ms. Linda K. Russell;Air Liquide Intellectual Property Dept., Suite 1800, 2700 Post Oak Blvd., Houston, TX, 77056, US

(21) Appl. No.: 11/279,707

(22) Filed: Apr. 13, 2006

Related U.S. Application Data
(60) Provisional application No. 60/682,555, filed on May 19, 2005.

(51) Int. Cl. G01D 21/00

(52) U.S. Cl. 116/206

(57) ABSTRACT

Embodiments of the invention provide devices and methods for determining the state of content contained within a vessel. Embodiments of the invention provide passive status indicators which change state relative to the lifetime of the content contained within the vessel. In one embodiment the status indicator may be a layered adhesive structure attached to the vessel which changes visibly over time relative to the lifetime of the fluid contained within the vessel. For example, the layered structure may change its color with time. In another embodiment, the status indicator may be an electronic timer attached to the vessel and to at least one of a plurality of indicators. The electronic timer may be configured to notify the user or users of the compressed fluid of the age of the compressed gas via the indicators.

### CROSS-REFERENCE TO RELATED APPLICATIONS

This application claims the benefit under 35 U.S.C. § 119(e) to provisional application No. 60/682,555, filed May 19, 2005, the entire contents of which are incorporated herein by reference.

### BACKGROUND

1. Field of the Invention

Embodiments of the present invention generally relate to an apparatus to indicate the lifetime of the content of a vessel.

2. Description of the Related Art

Some compressed gases have a limited lifetime specified by a provider of the compressed gas or by a regulatory agency. The limited lifetime may be communicated to the user of the compressed gas in the form of an expiration date. The expiration date may indicate to the user when the gas is no longer appropriate for its intended use.

One reason to have an expiration date is to control the quality or the composition of a gas or a gas mixture for a particular laboratory experiment or manufacturing process. For example, if an amount of time has passed such that a change in the quality of the gas has been effected, undesirable results in an experiment or a manufacturing process results may occur.

Another reason to have an expiration date is to control the quality of a gas which is intended to be used as a drug for human use. For example, oxygen administered to a patient is one such gas. If an amount of time has passed such that a change in the quality of the gas has been effected, the use of the gas on humans may be dangerous.

Currently, the monitoring of gas cylinders and their corresponding expiration dates is handled by dedicated gas management personnel. A compressed gas supplier may provide an indication of the lifetime of the compressed gas (i.e., the expiration date) to the users of the gas. The indication may be given to the users in the form of an expiration date written on a receipt received when the compressed gas cylinder is delivered (e.g., attached to the cylinder itself), or the expiration date may be written directly onto a gas cylinder delivered to a customer. Dedicated gas management personnel may regularly check the expiration dates of all cylinders under his or her control and compare the dates with the current date. When the gas is approaching or has reached the end if its useful life, for example by the arrival of the expiration date, the gas manager may discontinue the use of that cylinder.

In such conditions monitoring the expiration date is a labor intensive task, and having dedicated gas management personnel is not completely effective because it introduces the risk of human error. For example, the dedicated manager may incorrectly copy an expiration date of a gas from a compressed gas cylinder to a log, and when the gas manager later reads the date from the manager may believe the gas is still good when in fact the expiration date has passed. The gas manager may also misread an expiration date on a gas cylinder and think the gas is still good when in fact the expiration date has passed. These and other types of human error related to gas management may have undesired or even deadly consequences.

Therefore, an improved method and apparatus is needed to track the useful life of a compressed gas and provide a warning if the gas is approaching or is past its useful life.

### SUMMARY

Embodiments of the invention generally provide apparatus and an improved method to track the useful life of a compressed gas and provide a warning if the gas is approaching or past its useful life.

In one embodiment of the invention a monitoring apparatus is provided. The monitoring apparatus generally comprising: a compressed fluid vessel containing a compressed fluid, wherein the compressed fluid undergoes one of a physical or chemical change at a known rate; and passive, time-evolving state indicator proximate to the vessel wherein the state indicator changes at substantially the known rate to visually indicate a state of the compressed fluid without interacting with the compressed fluid.

Another embodiment provides a monitoring apparatus. The monitoring apparatus generally comprising: a compressed gas cylinder containing a compressed gas, wherein the compressed gas undergoes one of a physical or chemical change at a known rate; and a passive, time-evolving state indicator proximate to the vessel wherein the state indicator changes at substantially the known rate to visually indicate a state of the compressed gas without interacting with the compressed gas.

Another embodiment provides a method of monitoring a change of a compressed fluid in a compressed fluid container, wherein the compressed fluid undergoes one of a physical or chemical change at a known rate. The method generally comprises activating a passive, time-evolving state indicator proximate to the compressed fluid vessel, wherein the state indicator changes at substantially the known rate to visually indicate a state of the compressed fluid without interacting with the compressed fluid.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a side view of a compressed fluid vessel provided with a state indicator, according to one embodiment of the invention;

FIGS. 2 and 3 are cross sectional views of state indicators, according to embodiments of the invention;

FIG. 4 is a time-elapsed side view of a compressed fluid vessel provided with a state indicator, according to another embodiment of the invention;

FIG. 5 is a side view of a compressed fluid vessel provided with an electronic state indicator, according to one embodiment of the invention; and

FIG. 6 is a time-elapsed side view of a compressed fluid vessel provided with an electronic state indicator, according to one embodiment of the invention.

### DESCRIPTION OF PREFERRED EMBODIMENTS

Embodiments of the invention provide devices and methods for determining the state of content contained within a vessel. The devices and methods may be considered passive because they do not interact with the content of the vessel. Embodiments of the invention provide status indicators which change state relative to the lifetime of the content contained within the vessel. In one embodiment, status indicators are time-evolving, meaning the indicators change with time. Time-evolving may generally refer to any change that can be visually appreciated by a human being. In this regard it is noted that while the visually appreciable change may be continuous, it may also refer to discrete (e.g., binary) changes. However, even in the latter case, the change is premised on the passage of time, and is, therefore, time-evolving.

In one embodiment the status indicator may be a layered adhesive structure which changes visibly over time. For example, the layered structure may change its color with time. The layered structure may change color over time due to a plurality of reasons. For example, the layered structure may change color over time due to exposure to environmental conditions, or due to the migration of an ink within the layered structure. The change in color of the layered structure is relative to the lifetime of the fluid contained within the vessel, thereby providing a visual indicator to determine the state of the compressed fluid contained within the vessel.

In another embodiment, the status indicator may be an electronic timer attached to the vessel and to at least one of a plurality of indicators. The electronic timer may be configured to notify the user or users of the age of the compressed fluid. For example, the electronic indicator may alert the user or users of the compressed fluid of the impending expiration of the lifetime of the compressed fluid via a blinking light. Furthermore, the electronic indicator may alert the user or users of the expiration of the lifetime of the compressed fluid by turning a light to a constant on state.

### EXAMPLES

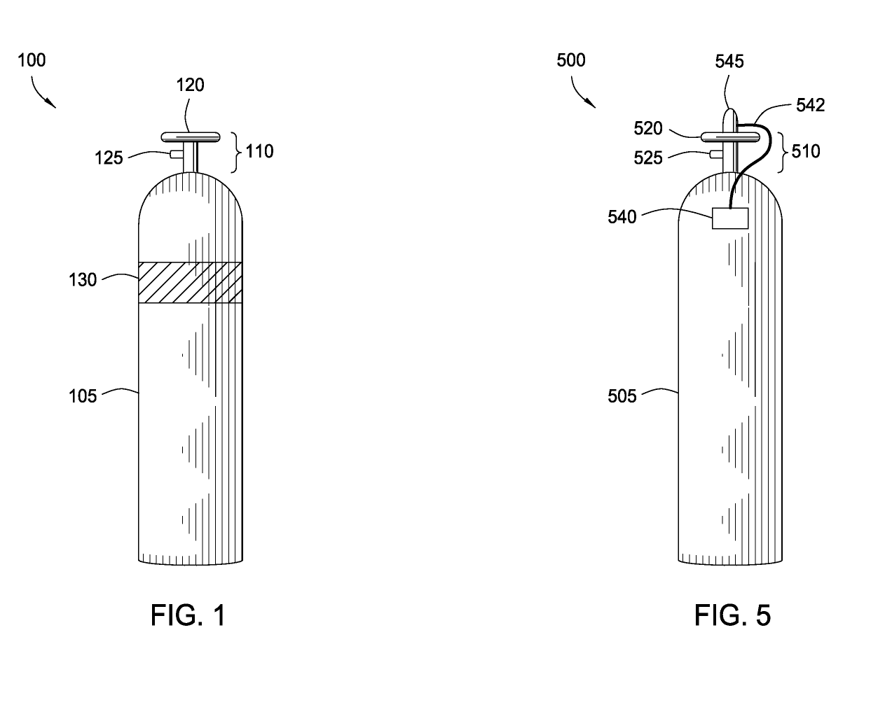

In one embodiment of the invention, a vessel 100, such as that seen in FIG. 1 may be provided. The vessel 100 may be any container constructed to hold a substance, such as a compressed fluid. For example, a vessel 100 may be a gas cylinder. A gas cylinder may be a vessel which is constructed to hold a gas or a liquid at a pressure higher than normal pressure (760 torr at 20° Celsius) and has a circular cross section.

The compressed fluid contained within the vessel may be any fluid capable of being contained within a vessel 100. The fluid may be a compressed gas or a liquefied compressed gas. In a particular embodiment, a compressed gas may be any material or mixture having either an absolute pressure exceeding 40 psia (3 bar) at 70° F. (21° C.) or an absolute pressure exceeding 104 psia (7 bar) at 130° F. (54° C.). Exemplary compressed gases may be nitrogen, hydrogen, oxygen, and helium. In a particular embodiment, a liquefied compressed gas may be a gas that is partially liquid at its charging pressure and a temperature of 70° F. (21° C.) Fahrenheit. Exemplary liquefied compressed gases are propane, argon, and nitrous oxide. The fluid within the vessel may also be contained at a sub-atmospheric pressure. For example, precursor gases for electronic process applications may be contained within a vessel at a sub-atmospheric pressure.

In one embodiment, the vessel 100 has a vessel body 105. The vessel body 105 may be constructed of any material of suitable strength to hold a compressed fluid (e.g., steel, aluminum, alloys, etc.).

Attached to the vessel body 105 may be a valve 110. The valve 110 may be used to control the intake or output of compressed fluids from the vessel body 105. A valve 110 may be constructed of materials such as brass, aluminum, stainless steel, copper, or the like. The valve 110 may be attached to the vessel body 105 by a threaded connection. The valve may have an inlet/outlet 125 for allowing compressed fluid to enter or leave the valve 110 and the vessel body 105. The valve 110 may have a rotatable or turnable knob 120 for opening and closing the valve 110, thereby allowing fluid to flow through the valve 110 and enter or exit the vessel body 105. When the valve 110 is rotated or turned to an open position the valve will allow compressed fluid to flow into or out of the vessel body 105, conversely when the valve 110 is rotated or turned to a closed position the valve 110 will not allow compressed fluid to flow into or out of the vessel body.

The vessel 100 may be provided with a state indicator, according to one embodiment of the invention. In one embodiment of the invention the state indicator may comprise a layered adhesive structure 130 as shown in FIG. 1. The layered adhesive structure 130 may be attached to the vessel 100. Although shown as a band attached around the circumference of the vessel body 105, other embodiments of the invention are envisioned. For example, the layered adhesive structure 130 may be provided in a different geometric shape or size, and/or provided on the vessel at different locations.

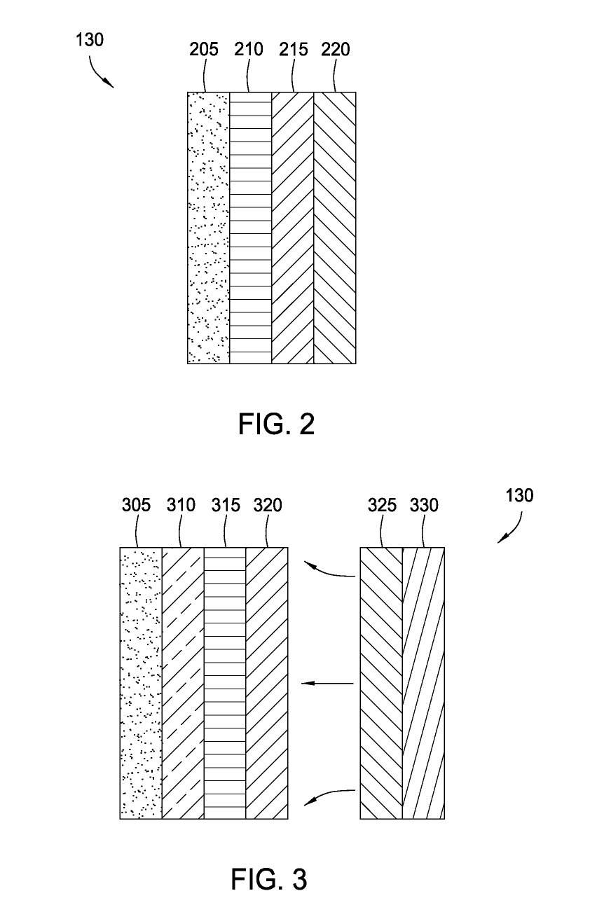

FIG. 2 is a cross sectional view of a state indicator such as a layered adhesive structure 130, according to one embodiment of the invention. In one embodiment of the invention, the layered adhesive structure 130 may have four layers. The layers may each have different chemical and/or physical properties. For example, one of the layers may be more susceptible to attacks from environmental attacks (e.g., from exposure to oxygen or ultraviolet radiation) while the others may not be as susceptible to attacks from environmental factors. The layers may be laid on top of one another to form a sandwich type structure. The layers may be laid on top of one another via a silk screen process.

A first layer 205 may be made of an adhesive which may enable the layered adhesive structure 130 to be attached to the vessel body 105. A second layer 210 may be attached or disposed on the first layer. The second layer 210 may be a colored inert layer which is not susceptible to environmental attacks. The second layer may be made of polyvinyl, polypropylene, polyester, or a similar substance. The color of the second layer 210 may be a color which is easily noticed by a user of the vessel 100 and may indicate or be associated with a warning situation or a terminal state (e.g., bright red or bright orange). The second layer may be colored with chemically inert pigments.

A third layer 215 of the layered adhesive structure 130 may be attached to or laid on the second layer. The third layer 215 may be more susceptible to environmental attacks, and therefore may degrade at a rate faster than the other layers.

The color of the third layer may acquired by the use of organic pigments made of azo compounds or azo by-products. The azo compound or azo by-product may be an alkaline-terrine salt azo with a sulfuric function, a double-azo, a tetra-double-azo, or sulfuric function azos, taken individually or in combination. The azo compounds are sensitive to chemical and physical conditions (oxygen, ozone, temperature, radiation, humidity, etc.). It is also possible to mix mineral oxides with the organic pigments in order to vary the sensitivity of the layer to environmental attacks. For example, titanium oxide may be mixed with the organic pigments.

The third layer may be colored such that there is a high contrast between the color of the second layer 210 and the color of the third layer 215, and such that the color of the third layer 215 does not indicate a warning situation or a terminal state. For example, the third layer 215 may have a green or a blue color.

A fourth layer 220 may be attached to or laid on the third layer 215. The fourth layer 220 may be able to withstand attacks from environmental conditions (oxygen, ozone, temperature, radiation, humidity, etc.). Thus, the fourth layer 220 protects the third layer 215 from environmental conditions until the fourth layer 220 is removed. The fourth layer 220 may be made of a substance resistant to chemical or physical attacks from various environmental sources. For example, the fourth layer may be made of polyethylene.

In one embodiment of the invention the fourth layer 220 may be removed to expose the third layer 215 to environmental factors which may cause the third layer to change over time. The fourth layer 220 may be removed at a time in close proximity to the beginning of the useful lifetime of the compressed fluid. For example, environmental factors such as the presence or oxygen or ultraviolet rays may cause the third layer 215 to degrade over time. This degradation over time will result in the deterioration of the material which makes up the third layer 215. After a sufficient amount of the third layer 215 has deteriorated the second layer 210 may become visible to the user of the compressed fluid. Initially, the second layer 210 may not be visible to the user, as it may be completely covered by the third layer 215. However, as more of the third layer 215 material degrades or deteriorates due to environmental exposure, more and more of the second layer 210 may become visible. If the colors of the second 210 and third 215 layers are chosen such that there is a high contrast between the two layers, there may be a clear visible differentiation between the two layers as the third layer 215 degrades. In one embodiment of the invention, the rate of degradation or deterioration of the third layer 215 may be chosen to correspond to the lifetime of the compressed fluid within the vessel 100. Thus, as the degradation or deterioration of the third layer 215 proceeds, the user is provided with a visual indication of the end of the useful lifetime of the compressed fluid.

In one embodiment of the invention, a color coded guide may be provided with the vessel 100 to enable the user to check the age of the compressed fluid by comparing the coloration of the layered adhesive structure 130 to the guide. The guide may provide a spectrum of colors along with a corresponding age of the compressed fluid. Thus, as the material progressively degrades or deteriorates over time the color of the adhesive layered structure 130 may be compared to the color on the guide.

FIG. 3 is a cross sectional view of another embodiment of a state indicator configured as a layered adhesive structure 130. In this embodiment of the invention, the layered adhesive structure 130 may change color due to the migration of ink. The layered adhesive coating may have six layers. The first layer 305 may be made of an adhesive which may enable the layered adhesive structure 130 to be attached to the vessel body 105.

The second layer 310 may be attached to or laid over the adhesive layer 305. The second layer 310 may be a support surface for the third layer 315. The third layer 315 may be a migrating ink or dye. The color of the ink or dye may be chosen such that it is indicative of a warning situation or a terminal state. For example, the color of the ink or dye may be a bright red or a bright orange color. The fourth layer 320 attached to or laid over the third layer 315 may be a barrier coating or film.

The fifth layer 325 may be an adhesive for attaching the fifth layer 325 to the fourth layer 320. An organic liquid may be dissolved in the adhesive of the fifth layer 325. For example, a plasticizer may be dissolved in fifth layer 325. The sixth layer 330 may be a support film for holding the fifth layer 325. The sixth layer 330 may be an acetate or polyester film.

The fifth 325 and sixth 330 layers may be placed on top of the fourth layer 320. The fifth layer 325 may be placed on top (i.e., in contact with) the fourth layer 320 at a time in relative proximity to the beginning of the lifetime of the compressed fluid. When the fifth layer 325 is placed on top of the fourth layer 320 the organic liquid in the fifth layer 325 may begin to dissolve the fourth layer 320. Once the organic liquid in the fifth layer 325 has dissolved the fourth layer 320 the migrating ink or dye in the third layer 315 may dissolve into the fifth layer 325 and become visible to the user of the vessel 100.

The fourth layer 320 may be selected such that the rate of dissolution of the fourth layer 320 when in contact with the fifth layer 325 is relative to the lifetime of the compressed fluid within the vessel 100. Thus, if the fifth layer 325 is placed on top of the fourth layer 320 at a time in relative proximity to the beginning of the lifetime of the compressed fluid, the ink may become visible at a point in relative proximity to the end of the useful lifetime of the compressed fluid.

The selection of the materials used to construct the different embodiments of the layered adhesive structures 130 may depend on the environment in which the vessel 100 will be located and the effect of that environment on the rate of change in color of the layered adhesive structure 130. For example, the environmental variables may be the amount of ultraviolet radiation exposure, the temperature of the environment, the humidity of the environment, the pressure of the environment, the amount of oxygen present in the environment, or any other environmental chemicals or variables which may affect the rate of change in color of the layered adhesive structure 130. Taking into consideration the environment in which the layered adhesive structure 130 and the vessel will be located, and the rate of change in color of the layered adhesive structure 130 when present in such an environment, the layered adhesive structure 130 may be selected such that the rate of change in color corresponds to the useful lifetime of the compressed fluid contained within the vessel 100.

In one embodiment of the invention the physical or chemical change of the layered adhesive structure 130 may commence at the point in time when the compressed fluid is delivered into the vessel 100 (i.e., the beginning of the lifetime of the compressed fluid). The commencement of the physical or chemical change of the layered adhesive structure 130 may be initiated according to the type of layered adhesive structure as described above (e.g., removing a protective layer or laying one layer on top of another layer). The layered adhesive coating may complete the change into another state, or color, when the useful lifetime of the compressed fluid has expired. Thus, the layered adhesive structure 130 may provide to the user of the compressed fluid a visual indication of the expiration of the useful life of the compressed fluid.

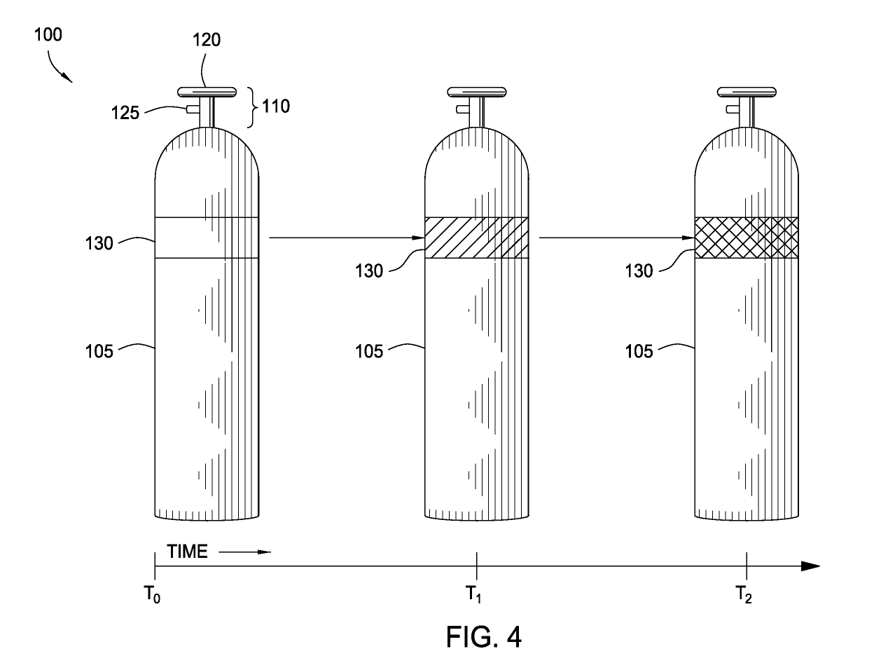

FIG. 4 is a time-elapsed side view of a compressed fluid vessel provided with a layered adhesive structure 130. Illustrated in FIG. 4 is a change in color over time of a layered adhesive structure 130. At some time relatively close to the commencement of the lifetime of the compressed fluid, for example time T₀, the layered adhesive structure 130 may be activated such that the physical or chemical change may commence. The activation of the layered adhesive structure 130 may coincide with the point in time when the fluid is placed into the vessel. Thus, as illustrated In FIG. 4, at time T₀ the layered adhesive structure 130 may be in an initial state.

In one embodiment of the invention, the initial state of the layered adhesive structure 130 may be a color indicating a non-terminal state or a non-warning type situation (e.g., blue, green, white, gray). Whereas, in the final state, the layered adhesive structure 130 may be a relatively bright color indicating a warning situation or a terminal state (e.g., red, orange, yellow). Thus, a high contrast between the initial color of the layered adhesive structure 130 and the final color of the layered adhesive structure 130 may provide a distinct indication to a user of the end of the useful lifetime of the compressed fluid.

Over time the layered adhesive structure 130 may change in color at a rate relative to the useful lifetime of the compressed fluid contained within the vessel 100. A slight change in the color of the layered adhesive structure 130 may be noticed at time T₁. This change in color may provide a visual indication to the user of the compressed fluid that the impending expiration of the fluid's useful lifetime is approaching.

Later, at time T₂, the change in color of the layered adhesive structure 130 may be finished. The final, finished coloration of the layered adhesive structure 130 may signify to the user of the compressed fluid and the corresponding vessel 100 that the fluid has reached the end of its useful lifetime.

In another embodiment of the invention, the change in color of the layered adhesive structure 130 may not be visible or ascertainable to the user of the vessel 100 until the time T₂ corresponding to the end of the useful lifetime of the compressed fluid. Thus, there may be little ascertainable change in the color of the layered adhesive structure 130 up to the time T₂; however, at time T₂ a rapid and readily ascertainable change in color may occur signifying to the user the end of the useful lifetime of the compressed fluid.

FIG. 5 is a side view of a vessel 100 provided with an electronic state indicator, according to one embodiment of the invention. The vessel 500 may be similar to the vessel described above with reference to FIG. 1. The vessel 500 may have a vessel body 505 and a valve 510. The valve may be made up of several components including, but not limited to, a knob 520 and an inlet/outlet 525.

The vessel 500 may also have an electronic status indicator attached to the vessel body 505. In one embodiment of the invention, the electronic status indicator may include a timer device 540 connected to an indicator via a wire 542. The indicator may be one or more of a plurality of devices which may provide an indication to a user of the vessel 500. For example, the indicator may be a piezoelectric speaker, a light bulb, a light emitting diode (LED), or a liquid crystal display (LCD). In one embodiment a light 545 is connected to the timer device 540 via a wire 542. The light 545 may be a light emitting diode (LED) according to one embodiment of the invention. The timer device 540 may be any suitable electronic timer which may be configured to change the state of the light 505 at a predetermined time. The wire 542 may be constructed of any type of material suitable to conduct electrical current. The light 545 may be mounted on the top of the knob 520, according to one embodiment of the invention. In other embodiments of the invention the light 545 may be mounted anywhere on the vessel 500.

FIG. 5 illustrates a change in the state of an electronic status indicator attached to the vessel 500 over time. In one embodiment of the invention, the change in state of the electronic status indicator may be accomplished by changing the state of the light 545 attached to the vessel body 505. A change in the state of the light 545 may inform the user of the compressed fluid of the end of the useful lifespan of the compressed fluid.

In one embodiment of the invention, the timer device 540 may be configured to activate the light 545 to several different states. One state of the light 545 may be an off state (i.e., no electromagnetic radiation of a visible wavelength is being emitted from the light 545). A third state of the light 545 may be an on state (i.e., the light 545 constantly emits electromagnetic radiation of a visible wavelength). Yet another state of the light 545 may be a blinking state (i.e., changing state from off to on intermittently).

The timer 540 may be configured to change the state of the light 545 relative to the useful lifetime of the compressed fluid. The initial state of the light 545 may be off. This initial state of the light 545 is illustrated in FIG. 5 at time T₀. The initial state of the light (e.g., the off state) may correspond to the beginning of, or in the early stages of, the useful lifetime of the fluid contained within the vessel 500.

As the compressed fluid ages and approaches the end of its useful lifespan timer may change the state of the light 545. At a predetermined time T₁, the state of the light 545 may be changed from an off state to a blinking state (illustrated in FIG. 5 as dashed lines). The blinking light 545 may indicate to the user of the compressed fluid that the useful lifetime of the compressed fluid may soon expire.

For example, a compressed fluid may have a useful lifetime of six months. In this example, the provider of the compressed fluid may set a time T₁ warning within the timer 540 at a time one month before the useful lifespan of the compressed fluid expires. Thus, when five months has passed, the timer 540 may set the state of the light 545 to blinking in order to notify the user. Once the user has been notified of only one month remaining he or she may take appropriate action. For example, the user may place an order for a new vessel containing compressed fluid.

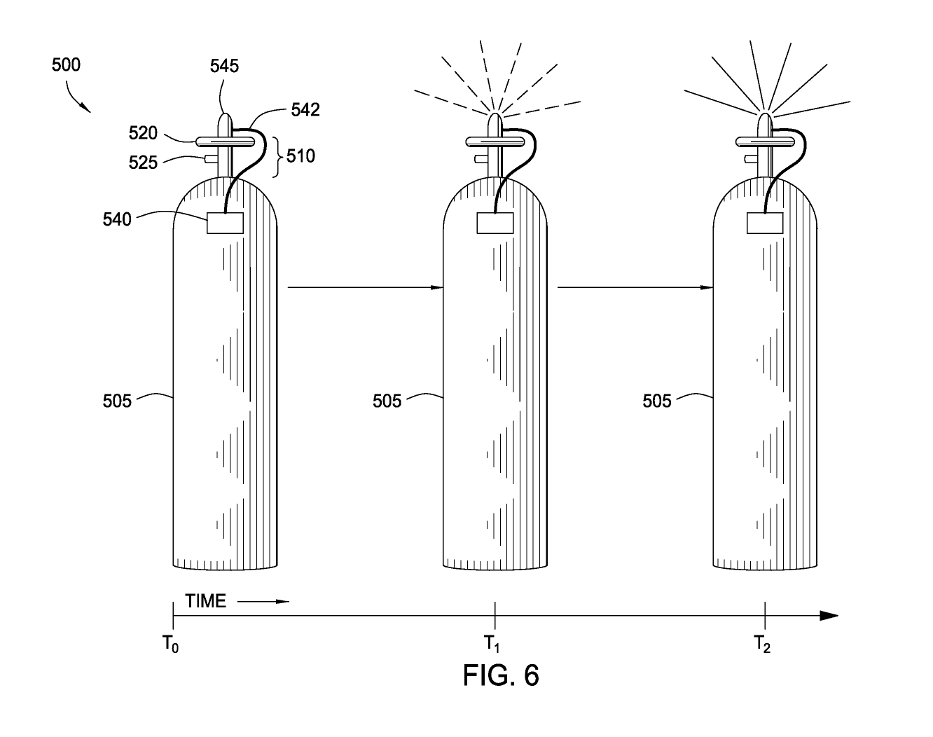

In one embodiment of the invention, the timer 540 may be configured to change the state of the light 545 to a constant on state at a predetermined time. This predetermined time may correspond to the end of the useful lifetime of the compressed fluid contained within the vessel 500. For example, in FIG. 6, the time T₂ may correspond to the end of the useful lifetime of the compressed gas.

Following with the example from above, the end of the useful lifetime of a compressed fluid may be six months, therefore in this example a time T₂ warning within the timer 540 may be set to six months. Thus, after six months the timer 540 may change the state of the light 545 to a constant on state. In one embodiment of the invention, the light may change state from a blinking state, as set at time T₁, to a constant on state at time T₂. In another embodiment of the invention, the timer 540 may change the state of the light 545 from an off state to an on state at time T₂ with no intervening blinking state. The constant on state may notify the user of the compressed fluid that the useful lifetime of the compressed fluid has expired and the user needs to take appropriate action. For example, an appropriate action may be that the user stops using the compressed fluid.

In another embodiment the timer 540 may be connected to a plurality of indicators. For example, the timer 540 may be connected to a plurality of lights. The timer 540 may incrementally illuminate each individual light upon the expiration of a predetermined time. For example, the timer 540 may be connected to an array of six lights and illuminates one additional light for each 30 day period which passes.

In conclusion, embodiments of the present invention provide devices and techniques to monitor the useful lifetime of a compressed fluid without interacting with the compressed fluid. In some embodiments, layered adhesive coatings which may change color over time may be used to provide indication of the duration of the useful lifetime of the compressed fluid. The layered adhesive coatings may change color due to a plurality of factors. For example, the layered adhesive coatings may change color due to environmental chemical attacks, or the layered adhesive coating may change color due to the migration of ink through visible layers of the layered adhesive coating. In other embodiments, an electronic timer device may be configured to provide an indication to the user of a compressed fluid of the duration of the useful lifetime of a compressed fluid. In one embodiment of the invention, the timer device may be connected to an indicator device which may indicate to the user the advancement of, or the arrival of the end of the useful lifetime of the compressed gas.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A monitoring apparatus, comprising:
a) a compressed fluid vessel containing a compressed fluid, wherein the compressed fluid undergoes one of a physical or chemical change at a known rate; and
b) a passive, time-evolving state indicator proximate to the vessel wherein the state indicator changes at substantially the known rate to visually indicate a state of the compressed fluid without interacting with the compressed fluid.

2. The apparatus of claim 1, wherein the state indicator comprises:
a) a timer; and
b) at least one light emitting diode connected to the timer.

3. The apparatus of claim 2, wherein the timer is configured to increment at substantially the known rate to change the output of the light emitting diode.

4. The apparatus of claim 3, wherein an initial state of the light emitting diode is off.

5. The apparatus of claim 4, wherein a second state of the light emitting diode is blinking.

6. The apparatus of claim 5, wherein a third state of the light emitting diode is constant on.

7. The apparatus of claim 1, wherein the state indicator comprises: a layered adhesive coating.

8. The apparatus of claim 7, wherein the layered adhesive coating comprises:
a) an adhesive layer;
b) a second colored inert layer not susceptible to environmental attacks disposed on the adhesive layer;
c) a third layer of a different color than the second layer and susceptible to environmental attacks disposed on the second colored inert layer; and
d) a fourth layer not susceptible to environmental attacks disposed on the third layer.

9. The apparatus of claim 8, wherein the third layer comprises: an organic pigment based on azo by-products.

10. The apparatus of claim 8, wherein the third layer comprises: a substance containing azo compounds susceptible to environmental attacks.

11. The apparatus of claim 8, wherein the third layer degrades due to environmental attacks at the known rate to make the second layer visible.

12. The apparatus of claim 8, wherein the fourth layer is removed at a point in time relative to the beginning of one of the physical or chemical changes of the fluid contained within the vessel.

13. The apparatus of claim 7, wherein the layered adhesive coating comprises:
a) an first adhesive layer;
b) a support surface layer disposed on the adhesive layer;
c) a migrating ink layer containing a migrating ink disposed on the support surface layer;
d) a barrier layer disposed on the migrating ink layer;
e) a second adhesive layer wherein an organic liquid is dissolved into the second adhesive layer and wherein the second adhesive layer dissolves the barrier layer when disposed on the barrier layer; and
f) a display layer comprising at least one of an acetate layer or a polyester layer disposed on the second adhesive layer.

14. The apparatus of claim 13, wherein once the second adhesive layer is placed on the barrier layer, at the known rate the dissolved organic liquid dissolves the barrier layer and the migrating ink migrates through the adhesive layer to become visible through the display layer.

15. The apparatus of claim 13, wherein the second adhesive layer is placed on the barrier layer at a point in time relative to the beginning of one of the physical or chemical changes of the fluid contained within the vessel

16. A monitoring apparatus, comprising:
a) a compressed gas cylinder containing a compressed gas, wherein the compressed gas undergoes one of a physical or chemical change at a known rate; and
b) a passive, time-evolving state indicator proximate to the vessel wherein the state indicator changes at substantially the known rate to visually indicate a state of the compressed gas without interacting with the compressed gas.

17. The monitoring apparatus of claim 16, wherein the state indicator comprises:
a) a timer; and
b) a light emitting diode connected to the timer, wherein the timer is configured to increment at substantially the known rate to change the output of the light emitting diode, wherein an initial state of the light emitting diode is off, a second state of the light emitting diode is blinking, and a third state of the light emitting diode is constant on.

18. The apparatus of claim 1, wherein the state indicator comprises: a layered adhesive coating.

19. The apparatus of claim 18, wherein the layered adhesive coating comprises:
a) an adhesive layer;
b) a second colored inert layer not susceptible to environmental attacks disposed on the adhesive layer;
c) a third layer of a different color than the second layer and susceptible to environmental attacks disposed on the second colored inert layer wherein the third layer comprises at least one of an organic pigment based on azo by-products or a substance containing azo compounds, wherein the third layer degrades due to environmental attacks at the known rate to make the second layer visible; and
d) a fourth layer not susceptible to environmental attacks disposed on the third layer, wherein the fourth layer is removed at a point in time relative to the beginning of one of the physical or chemical changes of the fluid contained within the vessel.

20. The apparatus of claim 18, wherein the layered adhesive coating comprises:
a) an first adhesive layer;
b) a support surface layer disposed on the adhesive layer;
c) a migrating ink layer containing a migrating ink disposed on the support surface layer;
d) a barrier layer disposed on the migrating ink layer;
e) a second adhesive layer wherein an organic liquid is dissolved into the second adhesive layer and wherein the second adhesive layer dissolves the barrier layer when disposed on the barrier layer; and
f) a display layer comprising at least one of an acetate layer or a polyester layer disposed on the second adhesive layer, wherein once the second adhesive layer is placed on the barrier layer, at the known rate the organic liquid dissolves the barrier layer and the migrating ink migrates through the adhesive layer to become visible through the display layer, and wherein the second adhesive layer is placed on the barrier layer at a point in time relative to the beginning of one of the physical or chemical changes of the fluid contained within the vessel.

21. A method of monitoring a change of a compressed fluid in a compressed fluid container, wherein the compressed fluid undergoes one of a physical or chemical change at a known rate, comprising:
activating a passive, time-evolving state indicator proximate to the compressed fluid vessel, wherein the state indicator changes at substantially the known rate to visually indicate a state of the compressed fluid without interacting with the compressed fluid.

22. The method of claim 21, further comprising: monitoring the state indicator for the change in state.

23. The method of claim 22, wherein the state indicator comprises:
a) timer; and
b) at least one light emitting diode connected to the timer.

24. The method of claim 22, wherein the state indicator comprises, a layered adhesive coating.

25. The method of claim 22, wherein monitoring the state indicator for a change comprises comparing the color of the state indicator to a guide which relates state indicator color to the change in the state of the compressed fluid.
